(19) United States
(12) Patent Application Publication
(10) Pub. No.: US 2021/0369427 A1
(43) Pub. Date: Dec. 2, 2021

(54) STOMATOLOGICAL NEGATIVE PRESSURE MOUTH GAG PATENT AND ITS USAGE

(71) Applicant: CHANGSHA EASYINSMILE INTELLIGENCE TECHNOLOGY CO,LTD, Changsha (CN)

(72) Inventors: Tiran ZHANG, Changsha (CN); Dan GUO, Changsha (CN)

(21) Appl. No.: 17/070,904

(22) Filed: Oct. 14, 2020

(30) Foreign Application Priority Data
May 26, 2020 (CN) 202010452008.7

(51) Int. Cl. A61C 17/08; A61C 17/10; A61C 5/40

(52) U.S. Cl. CPC A61C 17/08; A61C 5/40; A61C 17/10

(57) ABSTRACT

The invention is about a stomatological negative pressure mouth gag and its usage, which falls into the scope of stomatological technologies. The upper and lower wings of the mouth gag is connected by a thin-walled tube. The inner wall of the thin-walled tube is in direct contact with the lips, while its outer wall is exposed to the oral cavity. There are holes or slots evenly distributed on the outer wall of the thin-walled tube mounted along the arc-shaped lip holders. The left and right lip holders are connected by a negative pressure catheter between them. The thin-walled tubes on the left and right sides join with the negative pressure catheter and form a complete structure with it.

### CROSS-REFERENCE TO RELATED APPLICATIONS

This application claims priority to Chinese Patent Application No. 202010452008.7 with a filing date of May 26, 2020. The content of the aforementioned application, including any intervening amendments thereto, are incorporated herein by reference.

### TECHNICAL FIELD

The invention involves a stomatological negative pressure mouth gag and its usage, which falls into the scope of stomatological technologies.

### TECHNOLOGICAL BACKGROUND

In the process of orthodontic clinical treatment, the mouth gag is regularly used as an auxiliary apparatus. As shown in picture 5, the mouth gag using existing technology is composed of the connecting rod (10) and the left and right arc-shaped lip holders (2). The connecting rod (10) takes an arc shape, which joins the two arc-shaped lip holders (2) sideways into a complete structure. An arc-shaped lip holder (2) includes the upper wing (21), the lower wing (22) and the thin wall (20) connecting the upper wing (21) and the lower wing (22). The inner side of the thin wall (20) is in direct contact with the lip while its outer side is exposed to the oral cavity.

When the mouth gag is used, both arc-shaped lip holders are propped against the left and right sides of the patient's open mouth in order to keep the mouth opened for administering stamotological treatment. However, there is a disadvantage of the existing technology, the spittle and tooth shards produced in the process of root canal treatment in the patient's oral cavity usually stick to the inner wall of the lip holder, which may not only affect the doctor's visual observation but also impair the doctor and patient's health in the course of treatment.

### Invention Description

This invention is for overcoming shortcomings of existing technologies and providing a stomatological negative pressure mouth gag and its usage.

According to technological plan of this invention, a negative pressure mouth gag is composed of the left and right arc-shaped lip holders, both of which have the upper and lower wings covering the lips and the thin-walled tubes connected between the wings. The inner wall of the thin-walled tube is in direct contact with the lips, while its outer wall is exposed to the oral cavity. Moreover, there are holes or slots evenly distributed on the outer wall of the thin-walled tube mounted along the arc-shaped lip holders. The left and right lip holders are connected by a negative pressure catheter between them. The thin-walled tubes on the left and right sides join with the negative pressure catheter and form a complete structure with it. The negative pressure catheter is connected with a negative pressure generator by a joint tube.

There is a square or round hole opened in the middle of the negative pressure catheter, which is exposed to the oral cavity.

The negative pressure catheter is separated into three airways by two inset partitions, with the middle airway going through the square or round hole and the other two airways going through the thin-walled tubes on both sides.

Usage of the invention is as follows:

Step 1. The doctor connects the negative pressure catheter to a negative pressure generator by a joint tube.

Step 2. The patient opens his mouth, the doctor fixes both the right and left arc-shaped lip holders onto the patient's lips symmetrically with the patient's philtrum as the center line.

Step 3. Start the negative pressure generator, and proceed with the stamotological treatment, then the spittle and tooth shards produced in the process of root canal treatment in the patient's oral cavity will be sucked into holes or slots on the thin-walled tubes and the square or round hole in the middle of the negative pressure catheter.

Benefits of this invention: the negative pressure mouth gag will effectively suck in the spittle and tooth shards produced in the process of root canal treatment in the patient's oral cavity, therefore, rendering the lip holder's inner wall clean of contaminants from therapeutic treatment and the doctor's visual observation clear and unaffected, as well as guaranteeing hygiene and health of the doctor and patient during the treatment.

### APPENDED PICTURES

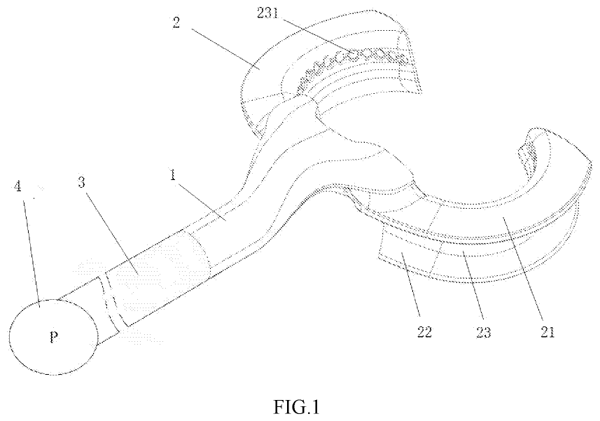

FIG. 1 is Graphic Model of the Invention.

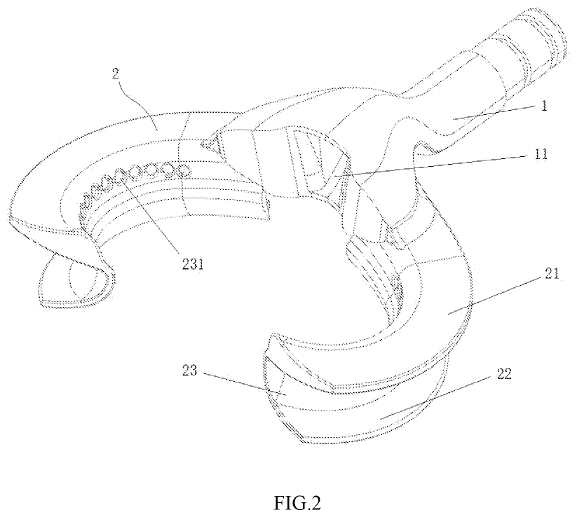

FIG. 2 is Diagrammatic Drawing (1) of the Arc-shaped Lip Holder and the Negative Pressure Catheter.

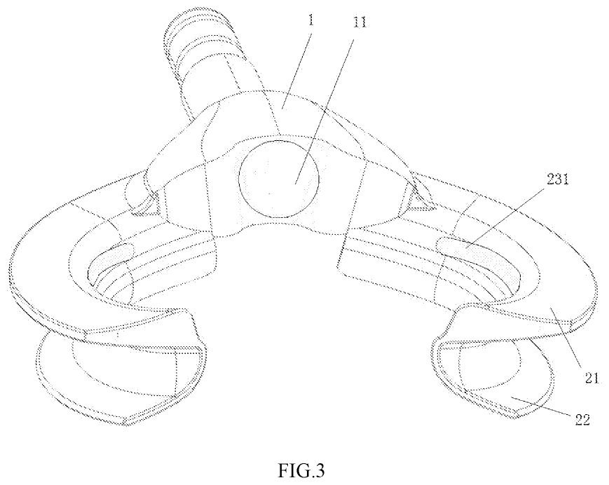

FIG. 3 is Diagrammatic Drawing (2) of the Arc-shaped Lip Holder and the Negative Pressure Catheter.

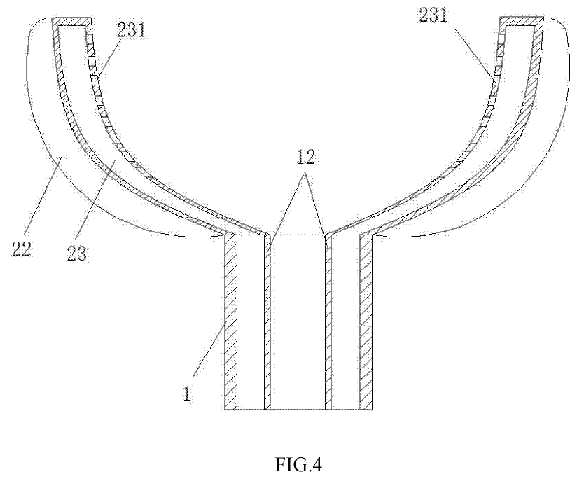

FIG. 4 is Sectional View of the Thin-walled Tube.

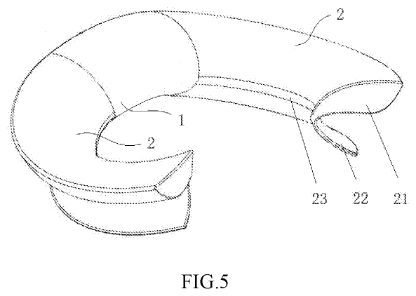

FIG. 5 is Structure of Existing Technology.

### WAY OF IMPLEMENTATION

Next, FIGS. 1-4 are used to explain the exemplary case of this invention. The negative pressure mouth gag is composed of the left and right arc-shaped lip holders (2), both of which have the upper wing (21) and lower wing (22) covering the lips and the thin-walled tubes (23) connected between the upper wing (21) and lower wing (22). The inner wall of the thin-walled tube (23) is in direct contact with the lips, while its outer wall is exposed to the oral cavity. Moreover, there are holes or slots (231) evenly distributed on the outer wall of the thin-walled tube (23) mounted along the arc-shaped lip holders (2). The left and right lip holders (2) are connected by a negative pressure catheter (1) between them. The thin-walled tubes (23) on the left and right sides join with the negative pressure catheter (1) and form a complete structure with it. The negative pressure catheter (1) is connected with a negative pressure generator (4) by a joint tube (3).

There is a square or round hole (11) opened in the middle of the negative pressure catheter (1), which is exposed to the oral cavity.

The negative pressure catheter (1) is separated into three airways by two inset partitions (12), with the middle airway going through the square or round hole (11) and the other two airways going through the thin-walled tubes (23) on both sides.

Usage of the invention is as follows:

Step 1. The doctor connects the negative pressure catheter (1) to a negative pressure generator (4) by a joint tube (3).

Step 2. The patient opens his mouth, the doctor fixes both the right and left arc-shaped lip holders (2) onto the patient's lips symmetrically with the patient's philtrum as the center line.

Step 3. Start the negative pressure generator (4), and proceed with the stamotological treatment, then the spittle and tooth shards produced in the process of root canal treatment in the patient's oral cavity will be sucked into holes or slots (231) on the thin-walled tubes (23) and the square or round hole (11) in the middle of the negative pressure catheter (1), therefore, rendering the lip holder's (2) inner wall clean of contaminants from therapeutic treatment and the doctor's visual observation clear and unaffected, as well as guaranteeing hygiene and health of the doctor and patient during the treatment.

The exemplary case of this invention is for including all similar substitutes and revamped and modified models of the exemplary case into the scope of rights claim to a broader sense. Therefore, any omission, modification, equivalent replacement and improvement made on the basis of the theory and principles of this invention shall be protected as the invention itself.

We claim:

1. A negative pressure mouth gag used for stomatological treatment, comprising a left arc-shaped lip holder and a right arc-shaped lip holder; the left arc-shaped lip holder and the right arc-shaped lip holder have upper and lower wings covering lips and thin-walled tubes connected between the wings; the inner wall of the thin-walled tube contacts with the lips, the outer wall of the thin-walled tube is exposed to the oral cavity;
wherein there are holes or slots evenly distributed on the outer wall of the thin-walled tube mounted along the arc-shaped lip holders;
wherein, the left and right lip holders are connected by a negative pressure catheter between them;
wherein, the thin-walled tubes on the left and right sides join with a negative pressure catheter and form a complete structure with the negative pressure catheter;
wherein, the negative pressure catheter is connected with a negative pressure generator by a joint tube.

2. The negative pressure mouth gag used for stomatological treatment according to claim 1, wherein there is a square or round hole opened in the middle of the negative pressure catheter, which is exposed to the oral cavity.

3. The negative pressure mouth gag used for stomatological treatment according to claim 1, wherein the negative pressure catheter is separated into three airways by two inset partitions, with the middle airway going through the square or round hole and the other two airways going through the thin-walled tubes on both sides.

4. A method of using the negative pressure mouth gag used for stomatological treatment according to claim 1, wherein has steps:
Step 1, a doctor connects the negative pressure catheter to a negative pressure generator by a joint tube;
Step 2, a patient opens his mouth, the doctor fixes both the right and left arc-shaped lip holders onto the patient's lips symmetrically with the patient's philtrum as the center line;
Step 3, start the negative pressure generator, and proceed with the stomatological treatment, then the spittle and tooth shards produced in the process of root canal treatment in the patient's oral cavity will be sucked into holes or slots on the thin-walled tubes and the square or round hole in the middle of the negative pressure catheter.
